(19) United States
(12) Patent Application Publication
(10) Pub. No.: US 2004/0178051 A1
(43) Pub. Date: Sep. 16, 2004

(54) Keyboard apparatus

(76) Inventor: Tomio Sato, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/796,119

(22) Filed: Mar. 10, 2004

(30) Foreign Application Priority Data
Mar. 10, 2003 (JP) P.2003-064222
Mar. 10, 2003 (JP) P.2003-064223

(51) Int. Cl. H01H 13/14

(52) U.S. Cl. 200/344

(57) ABSTRACT

A keyboard apparatus includes a frame, a link bearing provided on the frame and having an elongated hole, a link slidably engaged with the elongated hole of the link bearing, and a stopper provided on the frame so as to position the link at a first position in the elongated hole. The link is disposed at a first position in the elongated hole when a key top is assembled to the link.

Also, a keyboard apparatus includes a frame formed by a metal plate, a link bearing formed on the metal plate by sheet metal processing, a link connected to the link bearing and a key top connected to the link so that the key top is lifted and lowered.

### BACKGROUND OF THE INVENTION

This invention relates to a keyboard apparatus used for a computer, and more particularly to a keyboard apparatus designed to improve the assembling efficiency thereof and to reduce the number of parts and thickness of the apparatus.

There are various types of operating mechanisms for a keyboard apparatus. A keyboard apparatus formed so as to support a key top by a link mechanism is known as a keyboard apparatus of a thin structure suitable for a technical field of portable information terminals, such as a notebook type personal computer or a PDA which demands the miniaturization and the reduction of weight of the apparatus. This kind of keyboard apparatus is formed by connecting a key frame and the key top to each other by a plurality of links with the key top lifted by a cup-shaped rubber contact or a spring. The key frame constitutes a support base for a key top. The key top is moved vertically in a horizontally extending posture (refer to, for example, JP-A-2003-31067 (FIG. 1) and JP-A-2002-203449 (FIG. 1, FIG. 7)).

In a related art keyboard apparatus provided with a pantograph type link mechanism, a key matrix circuit-carrying membrane substrate is placed on a metal base frame or a metal plate-reinforced resin base frame. A resin key frame and a resin key top are mounted on the resultant membrane substrate. The base frame, the membrane substrate, the resin key frame, the rubber contact, the resin key top and a plurality of resin links per one key top are used, i.e., the number of kind of injection molded parts is large. Therefore, the manufacturing cost is high, and the assembling man-hour large.

By the way, the links are engaged with both of bearings of the key top and bearings of the key frame. The holes of all of the plural sets of bearings of the key frame or all of the bearings except one set of the bearings thereof are elongated holes. Sliding movements of lower ends of the links in the elongated holes enable the key top to be moved down.

In order to assemble the key top with the key frame of the apparatus, the links are assembled with the bearings of the key frame first, and lower surface opened type bearings provided on a lower surface of the key top are pressed against the links. As a result, the links and bearings are engaged with each other, and the key top is engaged with the key frame. However, in the key top engagement operation, the engagement operation cannot be attained when the positions of the bearings of the key top and those of the plural links are aligned with one another since the links are slidable with respect to the key frame.

FIG. 11 shows an example of a key frame of the related keyboard apparatus, and this key frame 101 is an injection molded resin part of the type on which two sets of link bearings 102, 103 are provided so that the link bearings extend at right angles to each other (the two sets of link bearings and two sets of links will now be referred to as X link bearings 102 and Y link bearings 103, and X link 104 and Y link 105 respectively). On a rear surface of the key top (not shown), lower surface opened type X link bearings and Y link bearings engageable with the X link 104 and Y link 105 are provided, and the positions of the X link bearings and Y link bearings on the key top have relation identical with that between an a point and a b point in FIG. 11. The positional relation between the X link 104 and Y link 105 and that between the X link bearings and Y link bearings on the key top are correspond to each other in a state that fulcrums of the Y link 105 are slid toward the out side end of the elongated holes of the Y link bearings 103 on the key frame 1.

When the key top in the state is pressed from the above against the X link 104 and Y link 105 with the key top set in accordance with the directions of the X link 104 and Y link 105, the X link 104 is engaged with the X link bearings, and the Y link 105 with the Y link bearings. As a result, the key top is fixed. However, since the Y link 105 is slidable, the Y link 105 deviates from b points in FIG. 12 in some cases as shown in the same drawing. When the Y link 105 is not in the predetermined b points, the Y link bearings and Y link 105 on the key top are not aligned with each other even when the key top is pressed down, so that the key top cannot be fixed to the base frame. Therefore, it is necessary in such a case that the Y link 105 is slid to the points b as shown in FIG. 11 by a manual operation, so that a key top fixing operation takes much labor and time.

It is therefore an object of the present invention to provide a keyboard apparatus capable of reducing the number of parts of the link type keyboard apparatus and also reducing the thickness thereof.

Further, an another object of the present invention is to provide a keyboard apparatus capable of facilitating the assembling of the key top with the base frame and thereby reduce the assembling man-hour.

### SUMMARY OF THE INVENTION

In order to achieve the above object, according to the present invention, there is provided a keyboard apparatus, comprising:

a frame, formed by a metal plate;

a link bearing, formed by subjecting the metal plate to a sheet metal process;

a link, connected to the link bearing; and

a key top, connected to the link so that the key top is lifted and lowered.

Preferably, the link is formed by subjecting a metal wire rod to a bending process.

Preferably, the link bearing is formed by subjecting the metal plate to a boring process and a cut-raising process.

Preferably, the link bearing is formed by subjecting the metal plate to an ejection process.

In the above configurations, link bearing is formed on a metal base frame by subjecting the metal base frame to sheet metal processing, and the link on the key top is fixed directly to the metal base frame. Therefore, the thickness of the keyboard apparatus decreases as compared with that of a related art keyboard structure in which a key frame is mounted on a base frame with the links of the key top fixed to the key frame. Moreover, the number of parts and assembling man-hour decrease, so that the cost also decreases.

Since the link formed by subjecting a metal wire rod to a bending process are used, the strength of the links is improved as compared with that of resin links used in a related art keyboard apparatus, and the cost also decreases.

Since the link bearing formed on the metal base frame can be obtained by a boring process and a cut-raising process or an ejection process, the processing cost decreases noticeably as compared with that of forming an injection molded link bearings of a resin.

According to the present invention, there is also provided a keyboard apparatus, comprising:

a frame;

a link bearing, provided on the frame and having an elongated hole;

a link, slidably engaged with the elongated hole of the link bearing; and

a stopper, provided on the frame, and positioning the link at an assembling position in the elongated hole,

wherein the link is disposed at the assembling position in the elongated hole when a key top is assembled to the link.

Preferably, the stopper has an inclined face. The link laid down on the frame is moved down along the inclined face of the stopper by its own weight so that the link is automatically set in the assembling position.

Preferably, the frame is constitutedbyametal plate. The link bearing and the stopper are formed by subjecting the metal plate to a sheet metal process so that a metal base frame for the keyboard apparatus is formed.

In the above configurations, when the key top is combined with a base plate, a link position regulating operation becomes unnecessary, and the assembling efficiency is improved noticeably. Moreover, even when the key top comes off while a user operates the keyboard apparatus, the key top can be combined with the base frame simply, so that the labor needed to carry out repair on the apparatus can be omitted.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a plan view of a metal base frame, showing a mode of embodiment of the present invention;

FIG. 2 is a plan view of the metal base frame with which links are combined;

FIG. 3 is a sectional view taken along the line A-A in FIG. 2, showing a key top combining step;

FIG. 4 is a sectional view taken along the line A-A in FIG. 2, showing an assembled keyboard apparatus;

FIG. 5 is a plan view of a metal base frame according to a second embodiment, in which links are combined with the metal base frame;

FIG. 6 is a sectional view taken along the line A-A in FIG. 5, showing an assembled keyboard apparatus;

FIG. 7 is a plan view of a metal base frame according to a third embodiment of the present invention;

FIG. 8 is a plan view of the condition of links combined with a metal base frame;

FIG. 9 is a sectional view taken along the line A-A in FIG. 8, showing a key top combining process;

FIG. 10 is a sectional view taken along the line A-A in FIG. 8, showing an assembled keyboard;

FIG. 11 is a plan view of a related art example in which links are combined with a key frame; and

FIG. 12 is a plan view of a related art example in which links are combined with a key frame.

### DETAILED DESCRIPTION OF THE PREFERRED EMBODIMENTS

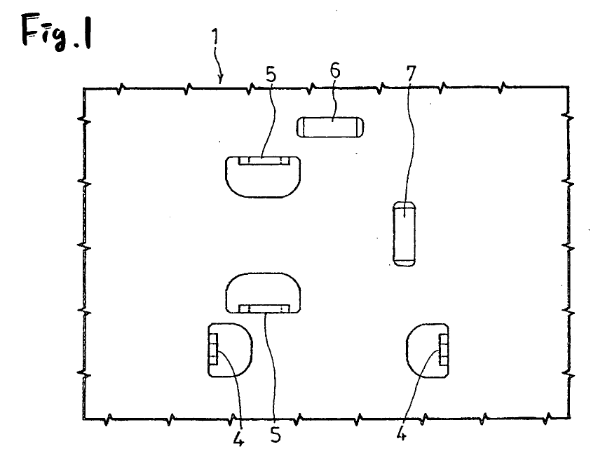

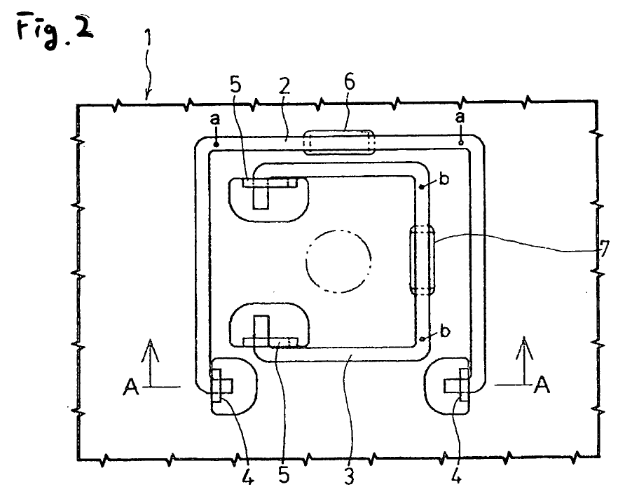

A first embodiment of the present invention will now be described in detail with reference to the drawings. FIG. 1 is a plan view of a metal base frame 1 of a keyboard apparatus, and FIG. 2 a plan view of a metal base frame 1 with which links 2, 3 are combined. The metal base frame 1 has link bearings 4, 5 formed by subjecting a metal plate, such as an iron plate to sheet metal processing. One of the characteristics of this apparatus resides in that links 2, 3 are fixed to the link bearings 4, 5 formed on the metal base frame 1 (the two links and two sets of link bearings will hereinafter be referred to as X link 2 and Y link 3 and X link bearings 4 and Y link bearings 5 respectively), and the use of a resin key frame as is provided in a related art keyboard apparatus is abolished.

The X link bearings 4 and Y link bearings 5 are formed by the boring process and the cut-raising process. The holes of the X link bearings 4 arranged laterally in front view are circular holes, and those of the Y link bearings 5 arranged longitudinally in the same view elongated holes. When a key top engaged with the X link 2 and Y link 3 is lifted and lowered, the X link 2 engaged with the X link bearings 4 is turned around the circular holes of the X link bearings 4, and a fulcrum of the Y link 3 engaged with the Y link bearings 5 is moved horizontally in the elongated holes of the Y link bearings 5 in accordance with the lifting and lowering of the key top, and the key top is lifted and lowered with a substantially horizontal posture maintained with respect to the metal base frame 21.

The X link 2 and Y link 3 shown in FIG. 2 are obtained by bend-molding a thin, cross-sectionally circular metal rod to the shape of a gate, which enables the cost to be reduced as compared with injection molded links of a resin used in a related art keyboard apparatus. The metal base frame 1 is provided in the positions thereon which correspond to central sections of front end portions of the X link 2 and Y link 3 with base seats 6, 7 formed by an ejection process so that the front end portions of the X link 2 and Y link 3 fixed to the X link bearings 4 and Y link bearings 5 is mounted on the base seats 6, 7, and lift slightly above an upper surface of the metal base frame 1. The reasons why this structure is formed reside in that it is necessary to render it possible to engage the bearings of the key top with the X link 2 and Y link 3 by pressing the key top from the above against the X link and Y link.

In order to assemble the keyboard apparatus, a membrane substrate is placed on the metal base frame 1 first which is shown in FIG. 1, and the X link 2 and Y link 3 are then fixed to the X link bearings 4 and Y link bearings 5 as shown in FIG. 2. A key contact and a rubber contact of the membrane substrate are positioned in a central portion of the base frame surrounded by the X link 2 and Y link 3.

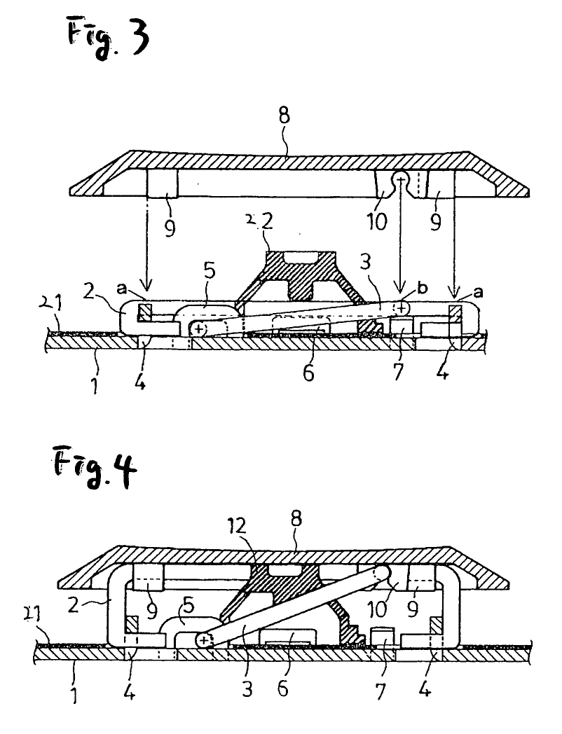

A resin key top 8 shown in FIG. 3 has lower surface-opened type X link bearings 9 and Y link bearings 10 engageable with the X link 2 and Y link 3 respectively. The X link bearings 9 and Y link bearings 10 are positioned on a points and b points. As shown in FIG. 2 and FIG. 3, the positions of the X link 2 and Y link 3 and those of the X bearings 9 and Y bearings 10 of the key top 8 in the condition in which the X link 2 is laid down with a fulcrum of the Y link slid to an outer end of each elongated hole of the Y link bearings 5 are aligned with each other. A reference numeral 21 denotes the membrane substrate, and a reference numeral 22 denotes the rubber contact.

When the key top 8 is set so as to adapt to the X link 2 and Y link 3 as shown in FIG. 3, and the key top 8 is pressed from the above against the X link 2 and Y link 3, the X link 2 is engaged with the X link bearings 9 of the key top 8, and the Y link 3 is engaged with the Y link bearings 10 thereof, so that the key top 8 is fixed. When the pressure is released from the key top 8 after the key top is fixed, the key top moves up perpendicularly by a restoring force of the rubber contact 22 to be put in the initial condition.

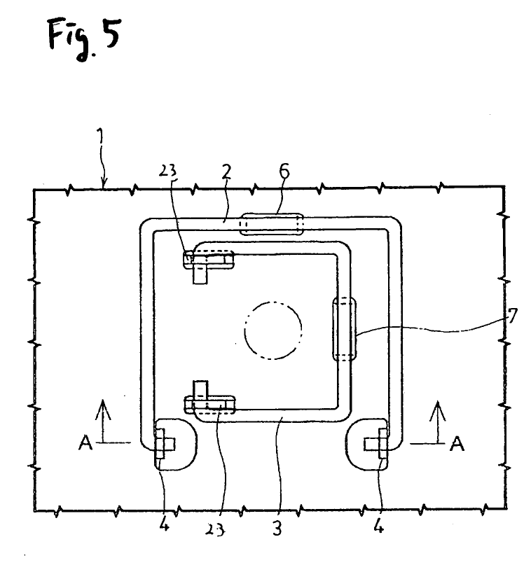

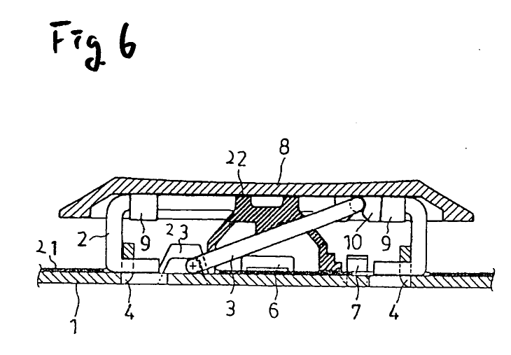

FIG. 5 and FIG. 6 show a base frame and a keyboard apparatus according to the second embodiment of the invention. The base frame has bridge type Y link bearings 23 formed by an ejection process using a press, instead of the Y link bearings 5 formed by the cut-raising process according to the first embodiment. In the X link bearings 4, holes thereof are circular. Since the holes of the X link bearings 4 are circular holes, it is preferable in view of the necessity of heightening the accuracy thereof to mold the holes by using a boring process and a cut-raising process. However, the holes of the Y link bearings are elongated holes, and do not demand an accuracy higher than that of the holes of the X link bearings. Therefore, the holes of the Y link bearings can be molded in one step by an ejection process. This enables the manufacturing man-hour to be reduced.

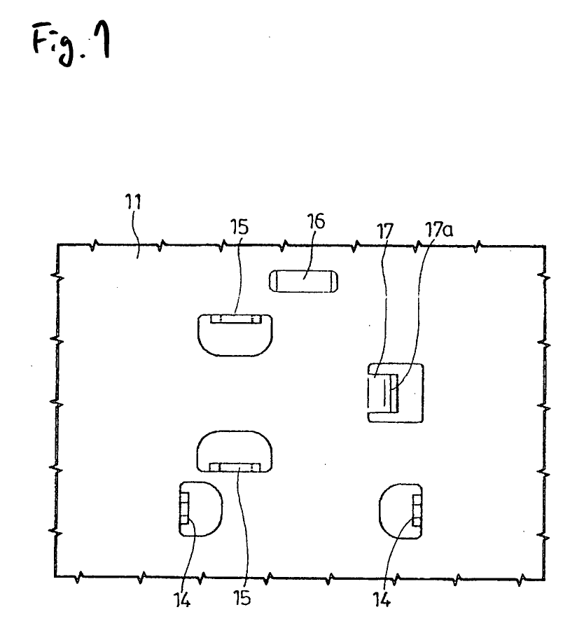

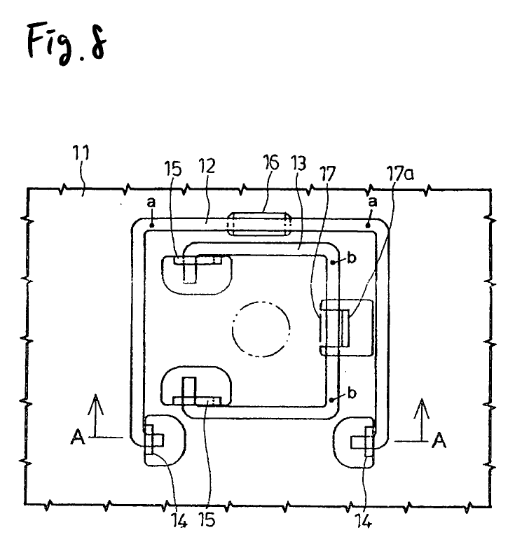

Next, the third embodiment of the present invention will now be described in detail with reference to the drawings. FIG. 7 is a plan view of a metal base frame 11 of a keyboard apparatus, and FIG. 8 a plan view of the metal base frame 11 on which an X link 12 and a Y link 13 are fixed. On the metal base frame 11, X link bearings 14 and Y link bearings 15 arranged at right angles to the bearings 14 are formed by subjecting a metal plate, such as an iron plate to sheet metal work. The X link 12 is fixed to the X link bearings 14, and the Y link 13 is fixed to the Y link bearings 15.

The X link bearings 14 and Y link bearings 15 are formed by the boring process and the cut-raising process. The holes of the X link bearings 14 arranged laterally in front view are circular holes, and those of the Y link bearings 15 arranged longitudinally in the same view elongated holes. When a key top engaged with the X link 12 and Y link 13 is lifted and lowered, the X link 12 engaged with the X link bearings 14 is turned around the circular holes of the X link bearings 14, and a fulcrum of the Y link 13 engaged with the Y link bearings 15 is moved horizontally in the elongated holes of the Y link bearings 15 in accordance with the lifting and lowering of the key top, and the key top is lifted and lowered with a substantially horizontal posture maintained with respect to the metal base frame 11.

The X link 12 and Y link 13 shown in FIG. 8 are products obtained by bend-molding a thin metal rod to a gate-like shape, and permit the cost to be reduced as compared with the links injection molded out of a resin and used for a related art keyboard apparatus. The metal base frame 11 has anX link base seat 16 and a Y link base seat 17 in the positions thereon which correspond to central portions of front ends of the X link 12 and Y link 13. The front end sections of the X link 12 and Y link 13 fixed to the X link bearings 14 and Y link bearings 15 are mounted on the X link base seat 16 and Y link base seat 17 respectively so that the mentioned sections of the X link and Y link lift slightly from an upper surface of the metal base frame 11. The reason why the X and Y links are lifted from the metal base frame 11 resides in that it is necessary to enable the X link 12 and Y link 13 to be engaged with the lower surface opened type bearings of the key top by pressing the key top from the above against the X link 12 and Y link 13.

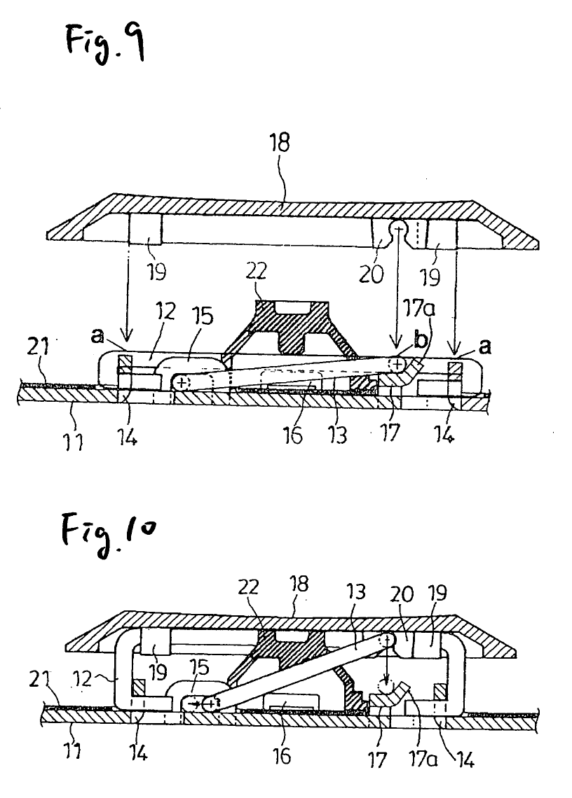

The base seat 17 for the Y link is formed by a cut-raising process, and an outer edge portion of the base seat is bent upward to form a stopper portion 17a. The stopper portion 17a positions the Y link 13 placed on the Y link base seat 17 at a predetermined position. In short, when the Y link is engaged with the metal base frame 11 and laid down, an upper end portion of the Y link 13 placed on the Y link base seat 17 as shown in FIG. 9, and is position-regulated by the stopper portion 17a and positioned in a b point, a fulcrum of a lower portion of the Y link 13 is positioned on an outer end of the elongated holes of the Y link bearings 15. The stopper portion 17a has an inclined surface. Therefore, when the Y link 13 is brought down on the Y link base seat 17 with the Y link slid rightward in the drawing, the upper end portion is lowered along the inclined surface and aligned automatically with the b points.

Thus, when the Y link 13 is engaged with the metal base frame 11 supporting the key top 18, the Y link is set in a predetermined position, and the X link 12 and Y link 13 are set in positions corresponding to the X link bearings 19 and Y link bearings 20 of the key top 18. Therefore, unlike the related art keyboard apparatus, the keyboard apparatus according to the third embodiment of the present invention becomes unnecessary to carry out an operation for regulating the positions of the links during the key top combining work. A reference numeral 21 denotes a membrane substrate, and a reference number 22 denotes a rubber contact.

In order to assemble the keyboard apparatus, a membrane substrate (not shown) is placed on such a metal base frame 11 first as is shown in FIG. 7. As shown in FIG. 8, an X link 12 and a Y link 13 are fixed to X link bearings 14 and Y link bearings 15 respectively. On a central portion of the base frame 11 surrounded by the X link 12 and Y link 13, a key contact and a rubber contact 22 of the membrane substrate 21 are positioned.

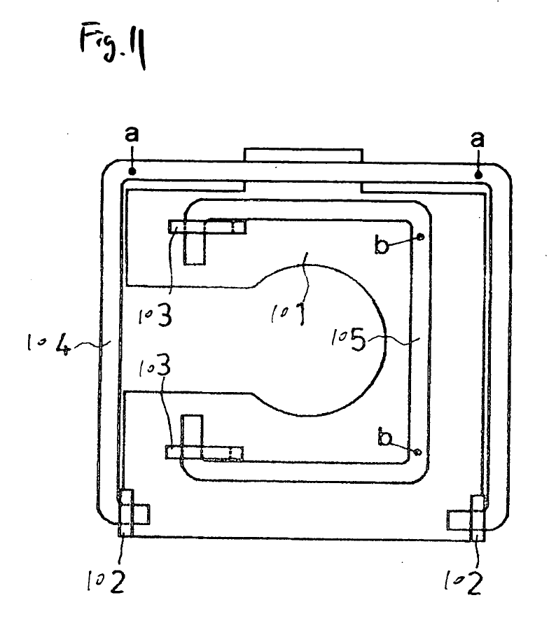

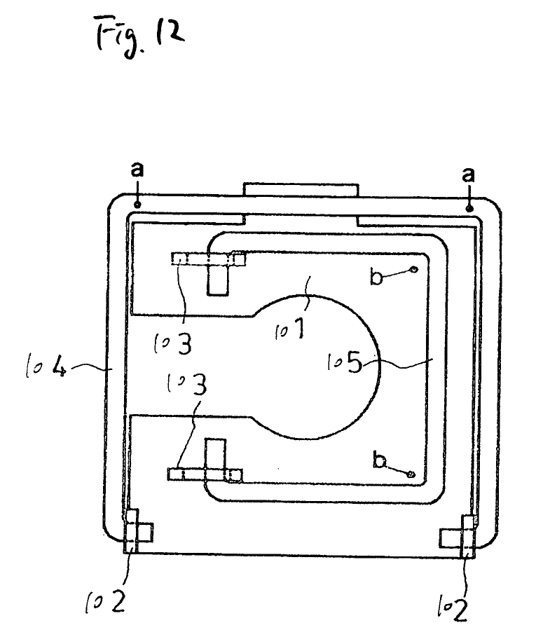

A key top 18 made of a resin and shown in FIG. 9 is provided with lower surface opened type X link bearings 19 and Y link bearings 20 engageable with the X link and Y link 13. When the key top 18 is pressed from the above against the X link 12 and Y link 13 with the key top 18 directed toward the X link 12 and Y link 13, the X link 12 is engaged with the X link bearings 19 of the key top 18, and the Y link 3 with the Y link bearings 20 of the key top 18, the key top 18 being thereby fixed. When the pressure of the key top 18 is released after the key top is fixed, the key top 18 moves up vertically owing to a restoring force of the rubber contact 12 to be put in an initial condition thereof shown in FIG. 10.

In the above embodiments, a structure formed by combining two links with each other in X-Y direction is shown as an example. The present invention is not limited to this structure, and a structure having two links arranged in parallel with each other may also be employed. Furthermore, it is also possible to make various modifications within the scope of the techniques according to the present invention, and it is natural that the present invention ranges over these modifications.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A keyboard apparatus, comprising:
a frame;
a link bearing, provided on the frame and having an elongated hole;
a link, slidably engaged with the elongated hole of the link bearing; and
a stopper, provided on the frame, and positioning the link at an assembling position in the elongated hole,
wherein the link is disposed at the assembling position in the elongated hole when a key top is assembled to the link.

2. The keyboard apparatus as set forth in claim 1, wherein the stopper has an inclined face; and
wherein the link laid down on the frame is moved down along the inclined face of the stopper by its own weight so that the link is automatically set in the assembling position.

3. The keyboard apparatus as set forth in claim 1, wherein the frame is constituted by a metal plate; and
wherein the link bearing and the stopper are formed by subjecting the metal plate to a sheet metal process so that a metal base frame for the keyboard apparatus is formed.

4. A keyboard apparatus, comprising:
a frame, formed by a metal plate;
a link bearing, formed by subjecting the metal plate to a sheet metal process;
a link, connected to the link bearing; and
a key top, connected to the link so that the key top is lifted and lowered.

5. The keyboard apparatus as set forth in claim 4, wherein the link is formed by subjecting a metal wire rod to a bending process.

6. The keyboard apparatus as set forth in claim 4, wherein the link bearing is formed by subjecting the metal plate to a boring process and a cut-raising process.

7. The keyboard apparatus as set forth in claim 4, wherein the link bearing is formed by subjecting the metal plate to an ejection process.
